(19) United States
(12) Patent Application Publication
(10) Pub. No.: US 2006/0034506 A1
(43) Pub. Date: Feb. 16, 2006

(54) Machine vision analysis system and method

(76) Inventors: James Mahon, Glasnevin (IE); James Tracey, Artane (IE); Malachy Rice, Cabenteely (IE)

Correspondence Address: PERMAN & GREEN, 425 POST ROAD, FAIRFIELD, CT, 06824, US

(21) Appl. No.: 11/202,575

(22) Filed: Aug. 12, 2005

(30) Foreign Application Priority Data
Aug. 13, 2004 (GB) 0418095.6

(51) Int. Cl. G06K 9/00

(52) U.S. Cl. 382/152

(57) ABSTRACT

A machine vision inspection system captures images of placed components and generates defect data. The defect data indicates defect components together with associated confidence scores. The confidence scores are generated according to factors such as the number of sides of a component lead at which paste has been detected (attribute factor), or measured component position (measurement factor). The confidence scores allow the placement machine to decide on how to act upon the defect data. They are also used by the inspection system to decide on which “visual watchpoint” series of component images to output for operator visual inspection.

### CROSS-REFERENCE TO RELATED APPLICATIONS

This application claims priority from British Patent Application No. 0418095.6, filed on Aug. 13, 2004.

### BACKGROUND

The invention relates to machine vision inspection by automated optical inspection (AOI) machines.

Our prior U.S. Pat. No. 6,580,961 describes a system in which inspection data is fed back in a closed loop to a placement machine so that placement errors can be corrected before becoming excessive. Also, it is known for inspection machines to provide data for guided repair stations and more specialised inspection systems for further and more detailed analysis of particular aspects.

However, a limitation on such direct machine-to-machine interfaces and indeed machine-to-operator interfaces is the extent to which the inspection data can be trusted.

The invention addresses this problem.

### SUMMARY OF THE INVENTION

According to the invention, there is provided a machine vision inspection system comprising a camera and an image processor storing target component attribute and measurement data, wherein the image processor generates an indication of a defect together with a confidence score value indicating confidence in the defect indication.

In one embodiment, the system determines confidence factors and combines the factors to generate a confidence score.

In another embodiment, the system generates an attribute confidence factor value and a measurement confidence factor value and combines said factor values to determine a confidence score.

In a further embodiment, a measurement confidence factor is determined by calculating footprint area of a component.

In one embodiment, the area is calculated by determining two-dimensional position data for a plurality of points on a component boundary as viewed in plan.

In another embodiment, a measurement confidence factor is calculated by determining the extent of skewing of a component.

In a further embodiment, an attribute confidence factor is calculated by determining the number of component sides at which solder paste is present.

In one embodiment, the position of a component image within a camera field of view is used to determine an attribute confidence factor.

In another embodiment, the image processor imposes a boundary around a centre of a field of view within which confidence is higher.

In a further embodiment, the system uses a priori assumptions to provide confidence factors.

In one embodiment, an a priori assumption is the believed effectiveness of a particular measurement for a particular device.

In another embodiment, the system uses a posteriori knowledge to improve confidence factors.

In a further embodiment, the a posteriori knowledge is applied by understanding how the results from a previous inspection differ from the expected results by review of defects and false failures.

In one embodiment, the system feeds the defect data back together with the confidence score to a production machine in real time.

In another embodiment, the system feeds the defect data together with the confidence score to a guided repair station.

In a further embodiment, the system uses the confidence score to determine sequence of output of inspection images.

In one embodiment, the system uses the confidence score to determine for which inspected section of a product a series of visual watchpoint images should be outputted.

In another embodiment, the system chooses the section according to the production machine part, which was involved in production of that section.

In another aspect, the invention provides a production control process carried out by an inspection system as defined above and a production machine, the inspection system inspecting products outputted by the production machine, the process comprising the steps of the inspection system feeding back defect data together with associated confidence scores to the production machine, and the production machine automatically deciding on responding to the defect data with reference to the confidence scores.

In one embodiment, the production machine is an electronic component placement machine, and the defect data is associated with a part of the placement machine.

In another embodiment, the inspection system outputs a series of images for a section of a type of product, and chooses the section according to the confidence scores.

### BRIEF DESCRIPTION OF THE DRAWINGS

The invention will be more clearly understood from the following description of some embodiments thereof, given by way of example only with reference to the accompanying drawings in which:—

FIG. 1 is a diagram showing a placed component;

FIG. 2 is a diagram showing points for positional parameter calculations;

FIG. 3 is a diagram showing a camera field of view and a boundary within the field of view; and

FIG. 4 is a pair of photographs showing correct and incorrect component placements and associated confidence scores.

### DETAILED DESCRIPTION OF THE PREFERRED EMBODIMENTS

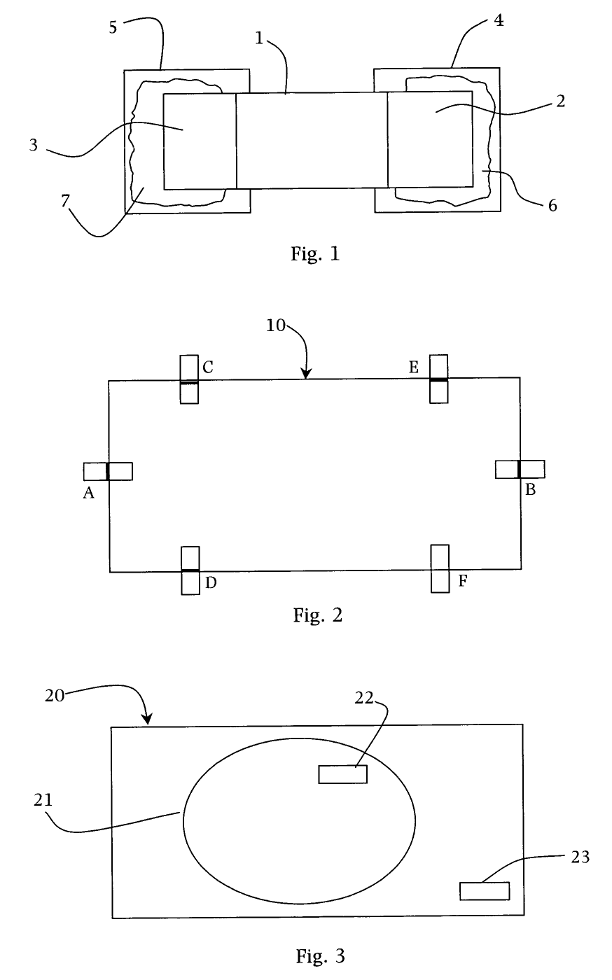

Referring to FIG. 1 a component has leads 2 and 3 and is placed on a PCB at pads 4 and 5 on which are solder deposits 6 and 7. An inspection system of the invention analyses colour at each of the three exposed sides of each lead 2 and 3. Thus, there is analysis of a total of six sides of the component 1 for paste inspection.

The inspection system automatically generates a confidence score for each pad as follows:
paste on one side: 50% confident of defect;
paste on two sides: 25% confident of defect;
paste on three sides: 0% confident of defect,

The system combines the confidence scores of both pads to arrive at an overall score of confidence that there is a defect. Determining presence/absence of paste is referred to as an attribute confidence factor.

In this example, each classified part of the component provides a confidence factor used to generate the overall score for confidence of there being a defect.

Referring to FIG. 2 the system generates a confidence score for component size verification. For a component 10 the system identifies six locations A-F around its periphery. Location parameters x and y are determined as follows:
x=(A+B)/2
y=((C+D)+(E+F))/4

Size parameters X and Y are determined as follows:
X=B−A
Y=C−D,E−F.

The determined values are compared with target values and the comparison yields a confidence score of there being a defect. The measurements which are made yield measurement confidence factors.

Referring to FIG. 3 a camera of the inspection system has a field of view 20. The image processor is programmed to recognise, within this field of view, a boundary 21. If the image data arises from within the boundary 21, such as a component 22, a higher confidence weighting is applied than if it arises outside such as at 23. These weightings fall under the category of attribute confidence factors.

The above processing results are used to yield a confidence score for:
Measure_Confidence=function (x-Confidence, y-Confidence, skew-Confidence)
Attribute_Confidence=function (Presence_Confidence, Orientation_Confidence, Joint_Confidence, OCR_Confidence, OCV_Confidence)

Individual confidence factors are important—each confidence score is derived from the individual confidence factors. For instance, the Joint_Confidence is derived from the feature data that is used to calculate the joint score. It may also be derived as an output from a classifier that is used to determine if the joint is good or bad. Therefore a confidence score will be a measure of its measurement and attribute confidence factors.

The above two confidence scores are combined to provide an overall confidence score in a range from 0.00 to 1.0. The 0.0 score indicates a defect but with very little confidence, while a score of 1.0 indicates a defect with the highest confidence. For example the 1.0 score would arise where the component is not present: yielding very high measurement and attribute confidences.

If the inspection system makes a measure for offset and finds this just marginally over the allowable offset limit this would result in a low measurement confidence score. This can be used to decrease the importance of this part measurement result in a closed loop or feed forward setup on a SMT production line.

In general, there are three main categories of confidence factors, as follows:
(a) A priori factors, either attribute or measurement. These depend on believed strength of the relationship between what is measured or detected and probability of a defect. For example, it may be known that the result of a particular check on a device will have a higher or lower probability of being correct or not. Consider for example the difference between 2D and 3D inspection of the same device. There may be a 2D inspection indicating presence, and a 3D inspection indicating absence because no profile could be measured. The system may apply a higher confidence score to the 3D measurement because it is looking at the third dimension.

(b) Actual performance, either attribute or measurement. This covers what is actually detected or measured or detected such as the paste detection (attribute) and position measurements (measurement) described above.

(c) A posteriori, either attribute or measurement. The system reviews past confidence performance. It uses this review to modify future score generation using a posteriori knowledge.

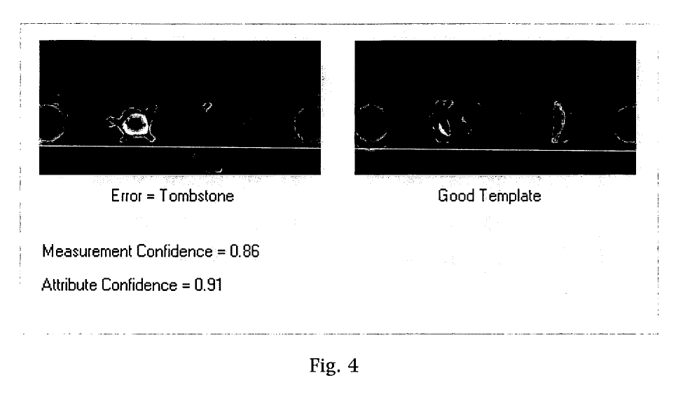

The generated defect confidence scores can be used to order the defects to a review or repair operator so that genuine defect calls are more likely to appear first. To reinforce this idea an image of the defect and the image of a known good part (taken as part of the training/setup stage of the inspection system) are presented to the operator, such as shown in FIG. 4.

In another instance, where two or more inspection machines (for instance AOI, AXI and ICT) are combined, the scores for the same devices can be combined using the confidence scores and measurement results.

Bayesian voting can be used to combine the scores.

In another instance, a system may have an error retry function: when a part fails, it is re-inspected in some other way to improve the accuracy of the measurement, which may be quite slow. If a confidence score is available, then if the defect confidence is high, there is no re-inspection to save inspection time. If the measurement is near the pass/fail threshold and the confidence is low, it can be re-inspected.

The following outlines some more confidence factors:

Attributes:
Distance from the threshold
Confidence in the measurement.
OCR/OCV: Match scores.
Polarity: Difference in grey levels

Measurements
Use a separate measurement technique and examine the difference between the answers.
Distance from the centre of the field of view (the further, the lower the confidence).
Contrast measures between the part and background, edge strengths, edge distances.

The confidence scores determined by the inspection machine are used to automatically generate an output. In one embodiment the score is fed back to a placement machine in closed loop feedback. Thus an engineer can set a minimum confidence score upon which the placement machine takes corrective action and a score band for which operator input is required.

In another embodiment the system uses the score to order the images of possibly faulty components to an operator. The highest-confidence score images are displayed firstly so that the operator has higher confidence in the system's output.

In a further embodiment the score is used to determine for which placement machine part (e.g. chip device or SOIC) a series of “visual watchpoint” images should be captured. This series will visually show an operator progression of operation of the placement machine part. This might visually demonstrate that a particular fault was a once-off, or it may demonstrate a progressive mis-alignment of the part.

An important advantage is that, because the system has automatically generated the score, decisions can be made for optimum use of the inspected data, either automatically or manually. The machines/stations which can benefit include:
placement or solder paste deposit machines in closed loop feedback, guided repair stations, and
visual watchpoint image capture and display functions.

The invention is not limited to the embodiments described but may be varied in construction and detail.

What is claimed is:

1. A machine vision inspection system comprising a camera and an image processor storing target component attribute and measurement data, wherein the image processor generates an indication of a defect together with a confidence score value indicating confidence in the defect indication.

2. A machine vision inspection system as claimed in claim 1, wherein the system determines confidence factors and combines the factors to generate a confidence score.

3. A machine vision inspection system as claimed in claim 2, wherein the system generates an attribute confidence factor value and a measurement confidence factor value and combines said factor values to determine a confidence score.

4. A machine vision inspection system as claimed in claim 3, wherein a measurement confidence factor is determined by calculating footprint area of a component; and the area is calculated by determining two-dimensional position data for a plurality of points on a component boundary as viewed in plan.

5. A machine vision inspection system as claimed in claim 2, wherein an attribute confidence factor is calculated by determining the number of component sides at which solder paste is present; and the position of a component image within a camera field of view is used to determine an attribute confidence factor; and the image processor imposes a boundary around a centre of a field of view within which confidence is higher.

6. A machine vision inspection system as claimed in claim 2, wherein the system uses a priori assumptions to provide confidence factors; and
wherein an a priori assumption is the believed effectiveness of a particular measurement for a particular device.

7. A machine vision inspection system as claimed in claim 2, wherein the system uses a posteriori knowledge to improve confidence factors; and
wherein the a posteriori knowledge is applied by understanding how the results from a previous inspection differ from the expected results by review of defects and false failures.

8. A machine vision inspection system as claimed in claim 1, wherein the system feeds the defect data back together with the confidence score to a production machine in real time.

9. A machine vision inspection system as claimed in claim 1, wherein the system uses the confidence score to determine for which inspected section of a product a series of visual watchpoint images should be outputted; and wherein the system chooses the section according to the production machine part which was involved in production of that section.

10. A production control process carried out by the inspection system of claim 1 and a production machine, the inspection system inspecting products outputted by the production machine, wherein the process comprises the steps of the inspection system feeding back defect data together with associated confidence scores to the production machine, and the production machine automatically deciding on responding to the defect data with reference to the confidence scores.

11. A production control process as claimed in claim 10, wherein the production machine is an electronic component placement machine, and the defect data is associated with a part of the placement machine.

12. A production control process as claimed in claim 10, wherein the inspection system outputs a series of images for a section of a type of product, and chooses the section according to the confidence scores.
